(19) United States
(12) Patent Application Publication
(10) Pub. No.: US 2024/0054871 A1
(43) Pub. Date: Feb. 15, 2024

(54) SURVEILLANCE AND/OR SECURITY SYSTEMS, EVENT PROCESSING, AND ASSOCIATED UNITS, SYSTEMS, METHODS, AND COMPUTER-READABLE MEDIA

(71) Applicant: LiveView Technologies, LLC, Orem, UT (US)

(72) Inventors: Scott Chun, Orem, UT (US); Krista Robinson, Orem, UT (US); Ross Maxfield, Orem, UT (US); Bryan Wright, Orem, UT (US); Brandon Woolf, Orem, UT (US); Jacob Crockett, Orem, UT (US)

(21) Appl. No.: 18/360,462

(22) Filed: Jul. 27, 2023

Related U.S. Application Data
(60) Provisional application No. 63/396,553, filed on Aug. 9, 2022.

(51) Int. Cl. G08B 13/196; G06V 20/52; G06V 10/70; H04N 7/18

(52) U.S. Cl. CPC G08B 13/19621; G06V 20/52; G06V 10/70; H04N 7/185

(57) ABSTRACT

Various embodiments relate to event processing. A system may include a mobile unit, which may include one or more sensors configured for capturing data and a controller for generating a number of events based on captured data. The system may further include a complex event processing (CEP) system communicatively coupled to the mobile unit. The CEP system may be configured to receive one or more of the number of events and generate one or more actions based on the one or more number of events. Associated systems, methods, and computer-readable media are also disclosed.

### PRIORITY CLAIM

This application claims the benefit of the filing date of U.S. Provisional Patent Application Ser. No. 63/369,553 filed Jul. 27, 2022, for “SECURITY SYSTEMS, AND ASSOCIATED MOBILE UNITS, METHODS, AND COMPUTER-READABLE MEDIA,” the disclosure of which is hereby incorporated herein in its entirety by this reference.

### TECHNICAL FIELD

This disclosure relates generally to surveillance and/or security, event processing, and related systems. More specifically, the disclosure relates to reactive and/or interactive systems, controllable and/or customizable systems, event processing systems, and related units, devices, methods, and computer-readable media.

### BACKGROUND

Conventional surveillance and/or security systems, which may capture data (e.g., via one or more sensors), may require a technician (i.e., a human) to view the data and take appropriate action, such as calling the police, turning on lights, and/or generating an audible response. However, humans are expensive and may be unreliable. Other systems may capture and record data (e.g., video) to be subsequently accessed by a user. In this scenario, although a system may capture an event (e.g., a crime being committed) (e.g., via one or more cameras), there is little to no deterrence and/or reaction while the event (e.g., the crime) is in process.

### BRIEF SUMMARY

At least one embodiment of the disclosure includes a system. The system may include a unit, which may include one or more sensors configured for capturing data and a controller for generating a number of events based on captured data. The system may further include a complex event processing (CEP) system communicatively coupled to the unit. The CEP system may be configured to receive one or more events of the number of events and generate one or more actions based on the one or more events.

Another embodiment includes a method of operating a system. The method may include capturing data via one or more sensors of a unit of the system. Further, the method may include generating, based on captured data, a number of events. The method may also include receiving, at a complex event processing (CEP) system, a number of rules and the number of events. Further, the method may include generating, via the CEP system, one or more actions based on one or more events of the number of events and at least one rule of the number of rules.

In another embodiment, a system may include a mobile unit and a mast coupled to the mobile unit. The system may further include a head unit coupled to the mast. The head unit may include one or more sensors configured for capturing data and a controller for generating events based on captured data. The system further includes a complex event processing (CEP) system communicatively coupled to the mobile unit. The CEP system may be configured to receive the events and generate one or more actions based on the events.

Another embodiment includes a non-transitory computer-readable media having computer instructions stored thereon. The instructions, in response to being executed by a processing device of a system, may cause the system to perform or control performance of operations. The operations may include generating, based on captured data, a number of events. The operations may further include receiving, at a complex event processing (CEP) system, a number of rules and the number of events. Further, the operations may include generating, via the CEP system, one or more actions based on one or more events of the number of events and at least one rule of the number of rules.

At least one other embodiment of the disclosure includes a system including a mobile unit. The mobile unit may include one or more output devices and one or more sensors. The mobile unit may further include at least one controller configured to control at least one output device of the one or more output devices responsive to data sensed via the one or more sensors.

In at least one other embodiment, a system includes a mobile unit positioned within an environment. The mobile unit includes one or more sensors to sense data within and/or around the environment. The mobile unit further includes one or more lights and one or more speakers. Further, the system includes a control unit configured to control operation of a light of the one or more lights, a speaker of the one or more speakers, or both, responsive to data sensed via the one or more sensors.

Another embodiment includes a method of operating a mobile unit comprising one or more sensors and one or more output devices. The method may include sensing, via the one or more sensors, data associated with an environment via the mobile unit positioned in or near the environment. The method may further include controlling operation of the one or more output devices based at least partially on the sensed data.

In yet another embodiment, a system includes a mobile unit, which includes one or more output devices. The surveillance system further includes at least one controller configured to control at least one output device of the one or more output devices responsive to at least one predetermined schedule.

### BRIEF DESCRIPTION OF THE DRAWINGS

FIG. 1 depicts an example system including a unit, in accordance with one or more embodiments of the disclosure.

FIGS. 2A-2C illustrate examples of a mobile unit, in accordance with various embodiments of the disclosure.

FIG. 3 depicts an example event processing system.

FIG. 4 illustrates another example event processing system, according to various embodiments of the disclosure.

FIG. 5 depicts an example system including a number of units and a server, in accordance with various embodiments of the disclosure.

FIG. 6 illustrates an example event processing system, in accordance with various embodiments of the disclosure.

FIG. 7 depicts another example system, according to various embodiments of the disclosure.

FIG. 8 illustrates another example system, in accordance with various embodiments of the disclosure.

FIG. 9 is an illustration of yet another example system, according to various embodiments of the disclosure.

FIG. 10 depicts another example system including a mobile unit, in accordance with various embodiments of the disclosure.

FIG. 11 depicts an example system including a mobile unit, a server, and one or more devices, in accordance with various embodiments of the disclosure.

FIG. 12 is a flowchart illustrating an example method of operating a system, according to various embodiments of the disclosure.

FIG. 13 is a flowchart illustrating an example method of operating a mobile unit, according to various embodiments of the disclosure.

FIG. 14 illustrates an example system, according to one or more embodiments of the disclosure.

### DETAILED DESCRIPTION

Referring in general to the accompanying drawings, various embodiments of the disclosure are illustrated to show example embodiments related to surveillance and/or security, event processing, and related units, systems, methods, and computer-readable media. It should be understood that the drawings presented are not meant to be illustrative of actual views of any particular portion of an actual circuit, device, system, or structure, but are merely representations which are employed to more clearly depict various embodiments of the disclosure.

The following provides a more detailed description of the present disclosure and various representative embodiments thereof. In this description, functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Event processing involves tracking and analyzing streams of data and information about things happening in the real world, known as “events,” and deriving a conclusion from the events. Complex event processing (CEP) is event processing that combines data from multiple data sources to infer events or patterns suggesting more complicated circumstances. More specifically, as described herein, CEP systems, in accordance with various embodiments of the disclosure, may efficiently integrate event information from multiple, heterogeneous data sources and exploit the power of a knowledge base for processing.

Various embodiments of the disclosure relate to complex event processing associated with a system, such as a surveillance and/or security system. For example, a system may include one or more units (e.g., mobile units), which may include one or more sensors configured for capturing data. Further, the system may include a controller for generating events based on captured data. In some embodiments, the controller may be within a unit (i.e., of the one or more units) and/or in a server (e.g., a cloud server). The system may also include one or more front-end devices (e.g., including a user device and/or an application programming interface (API)), which may also be configured to generate events.

The system may further include a complex event processing (CEP) system communicatively coupled to the one or more units and/or front-end devices. The CEP system may be configured to receive one or more events (e.g., from one or more units and/or front-end devices) and generate one or more actions based on the one or more events. The one or more actions may be and/or may cause one or more responses (e.g., acts), such as one or more outputs generated via one or more output devices (e.g., one or more lights, speakers, electronic displays, without limitation) of the one or more units, one or more notifications (e.g., email or text message conveyed to a user and/or an administrator (e.g., via a front-end)), and/or another response associated with the system. Actions may also include control of one or more units. For example, based on captured events, the functionality of one or more units may be controlled (e.g., adjusted). More specifically, for example, in response to sensed events, additional and/or different functionality (and/or additional data) may be requested of the one or more units.

Further, various embodiments disclosed herein relate to reactive and/or interactive systems. Yet more specifically, various embodiments relate to surveillance and/or security systems configured to interact with and/or to an environment. Stated another way, a system may be configured to sense its environment and react and/or interact accordingly via one or more responses. According to some embodiments, a system may be programmable (e.g., via a user) such that various sensed events may trigger various responses. Further, various embodiments relate to controllable and/or customizable systems. In some of these embodiments, a system may interact with and/or react to an environment with or without a CEP system (i.e., with or without utilizing CEP functionality).

According to some embodiments, a system may include a unit (e.g., a mobile unit), which may include one or more sensors (e.g., cameras, motion sensors, noise sensors, and/or other sensors) and one or more output devices (e.g., lights, speakers, electronic displays, and/or other output devices). In these embodiments, responsive to an event (e.g., a timing event, a detected event based on data sensed via the one or more sensors, a scheduled event, or other event), the unit may react (e.g., via one or more output devices) with a visual and/or audible response. More specifically, for example, in response to data sensed via the one or more sensors, an operation (also referred to herein as a “behavior”) of one or more lights of the unit may be modified. For example, a color of a light, a blinking pattern of a light, an intensity (e.g., illumination and/or blinking speed) of a light, and/or another behavior of a light of the unit may be modified in response to sensed data. Additionally or alternatively, in response to data sensed via the one or more sensors, an operation of one or more speakers of the unit may be modified. For example, an audible sound and/or audible message may be conveyed via a speaker in response to sensed data.

Further, according to some embodiments, a system may be programmed such that an associated unit (e.g., a mobile unit) exhibits one or more operations (e.g., via one or more lights and/or speakers) based on a schedule (e.g., a static or dynamic schedule). More specifically, for example, a system may be configured to display (e.g., via a mobile unit) certain light colors (e.g., via one or more lights) and/or convey certain audio (e.g., music, sounds, and/or messages conveyed via one or more speakers) based on an event, such as a holiday (e.g., Fourth of July, Memorial Day, etc.), an awareness event (e.g., breast cancer awareness month), a current or future community event (e.g., a sporting event, a concert, or other event), and/or another event. It is noted that in some embodiments, an event may be generated and/or detected locally at a unit (e.g., a mobile unit). Additionally or alternatively, in some embodiments, an event may be an external event and/or may be based on external data (e.g., data from the cloud, a weather alert, an Amber alert, etc.) originating from an external source (e.g., a 3rd party or another mobile unit).

Additionally or alternatively, some embodiments relate to controlling and/or customizing systems, and more specifically, to controlling and/or customizing systems based on one or more variables, such as a location of a system and/or a unit, a time (e.g., a time of day, a day of the week, a month of the year, etc.), and/or an event (e.g., sensed or scheduled). More specifically, for example, during certain times (e.g., on even days of a month, during daytime hours, during certain months of the year, etc.), one or more output devices of a unit of a system may be configured to operate according to a first configuration or schedule, and during other times (e.g., on odd days of a month, during nighttime hours, during certain months of the year, etc.), one or more output devices of the unit may be configured to operate according to a second configuration or schedule. In reactive-based embodiments, a system may react (e.g., in response to sensed data) in a first manner during some time periods (e.g., during daytime) and in a second, different manner during other time periods (e.g., during nighttime).

In some embodiments, the operation of one or more output devices of a unit may be randomized (e.g., to prevent repetitive behavior). For example, a system may respond one way upon detecting an event and another, different way upon detecting a similar event. In other embodiments, the operation of one or more output devices of a unit may be fixed (e.g., according to a schedule) (i.e., for at least a time period).

As will be appreciated, various embodiments disclosed herein may provide an intelligent system that may increase safety and/or awareness, deter crime and/or reduce loss for users thereof (e.g., users across various industries including, but not limited to, retail, construction, transportation, education, property management, law enforcement, housing, entertainment, and government) and may provide for an enhanced experience for customers of, and other individuals associated with, users of a system and/or unit operating according to various embodiments disclosed herein. For at least these reasons, various embodiments of the disclosure, as described more fully herein, provide a technical solution to one or more problems that arise from technology that could not reasonably be performed by a person, and various embodiments disclosed herein are rooted in computer technology in order to overcome the problems and/or challenges described above. Further, at least some embodiments disclosed herein may improve computer-related technology by allowing computer performance of a function not previously performed by a computer.

Although various embodiments are described herein with reference to security and/or surveillance systems and/or mobile security and/or mobile surveillance units, the present disclosure is not so limited, and the embodiments may be generally applicable to any system and/or device that may or may not include security and/or surveillance systems and/or units. Further, although some embodiments are disclosed with reference to a mobile unit, the disclosure is not so limited, and a person having ordinary skill will understand that various embodiments may be applicable to stationary units (e.g., stationary security/surveillance devices), such as a unit coupled to a stationary pole (e.g., a light pole), a structure (e.g., of a business or a residence), a tree, etc. Embodiments of the disclosure will now be explained with reference to the accompanying drawings.

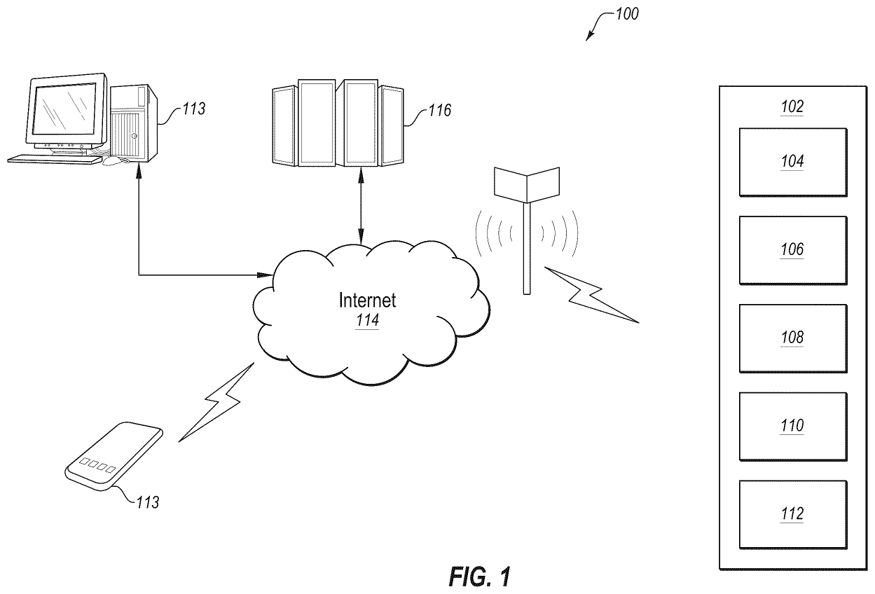

FIG. 1 illustrates a system 100, according to one or more embodiments of the disclosure. System 100, which may include a security and/or surveillance system, includes a unit 102, which may also be referred to herein as a “mobile unit,” a “mobile security unit,” a “mobile surveillance unit,” a “physical unit,” or some variation thereof. According to various embodiments, unit 102 may include one or more sensors (e.g., cameras, weather sensors, motion sensors, noise sensors, chemical sensors, without limitation) 104 and one or more output devices 106 (e.g., lights, speakers, electronic displays, without limitation). For example only, sensors 104 may include one or more cameras, such as thermal cameras, infrared cameras, optical cameras, PTZ cameras, bi-spectrum cameras, any other camera, or any combination thereof. Further, for example only, output devices 106 may include one or more lights (e.g., flood lights, strobe lights (e.g., LED strobe lights), and/or other lights), one or more speakers (e.g., two-way public address (PA) speaker systems), any other suitable output device (e.g., a digital display), or any combination thereof.

In some embodiments, unit 102 may also include one or more storage devices 108. Storage device 108, which may include any suitable storage device (e.g., a memory card, hard drive, a digital video recorder (DVR)/network video recorder (NVR), internal flash media, a network attached storage device, or any other suitable electronic storage device), may be configured for receiving and storing data (e.g., video, images, and/or i-frames) captured by sensors 104. In some embodiments, during operation of unit 102, storage device 108 may continuously record data (e.g., video, images, i-frames, and/or other data) captured by one or more sensors 104 (e.g., cameras, lidar, radar, environmental sensors, acoustic sensors, without limitation) of unit 102 (e.g., 24 hours a day, 7 days a week, or any other time scenario).

Unit 102 may further include a computer 110, which may include memory and/or any suitable processor, controller, logic, and/or other processor-based device known in the art. Moreover, although not shown in FIG. 1, unit 102 may include one or more additional devices including, but not limited to, one or more microphones, one or more solar panels, one or more generators (e.g., fuel cell generators), or any combination thereof. Unit 102 may also include a communication device (e.g., a modem (e.g., a cellular modem, a satellite modem, a Wi-Fi modem, etc.)) 112, which may comprise any suitable and known communication device, which may be coupled to sensors 104, output devices 106, storage device 108, and/or computer 110 via wired connections, wireless connections, or a combination thereof. In some embodiments, communication device 112 may include one or more radios and/or one or more antennas.

System 100 may further include one or more electronic devices 113, which may comprise, for example only, a mobile device (e.g., mobile phone, tablet, etc.), a desktop computer, or any other suitable electronic device including a display. Electronic device 113 may be accessible to one or more end-users. Additionally, system 100 may include a server 116 (e.g., a cloud server), which may be remote from unit 102. Communication device 112, electronic devices 113, and server 116 may be coupled to one another via the Internet 114.

According to various embodiments of the disclosure, unit 102 may be within a first location (a “camera location” or a “unit location”), and server 116 may be within a second location, remote from the first location. In addition, each electronic device 113 may or may not be remote from unit 102 and/or server 116. As will be appreciated by a person having ordinary skill in the art, system 100 may be modular, expandable, and/or scalable.

As noted above, in some embodiments, unit 102 may include a mobile unit (e.g., a mobile security/surveillance unit). In these and other embodiments, unit 102 may include a portable trailer (not shown in FIG. 1), a storage box (e.g., including one or more batteries) (not shown in FIG. 1), and a mast (not shown in FIG. 1) coupled to a head unit (e.g., including, for example, one or more cameras, one or more lights, one or more speakers, and/or one or more microphones) (not shown in FIG. 1). According to various examples, in addition to sensors and output devices, a head unit of unit 102 may include and/or be coupled to storage device 108, computer 110, and/or communication device 112.

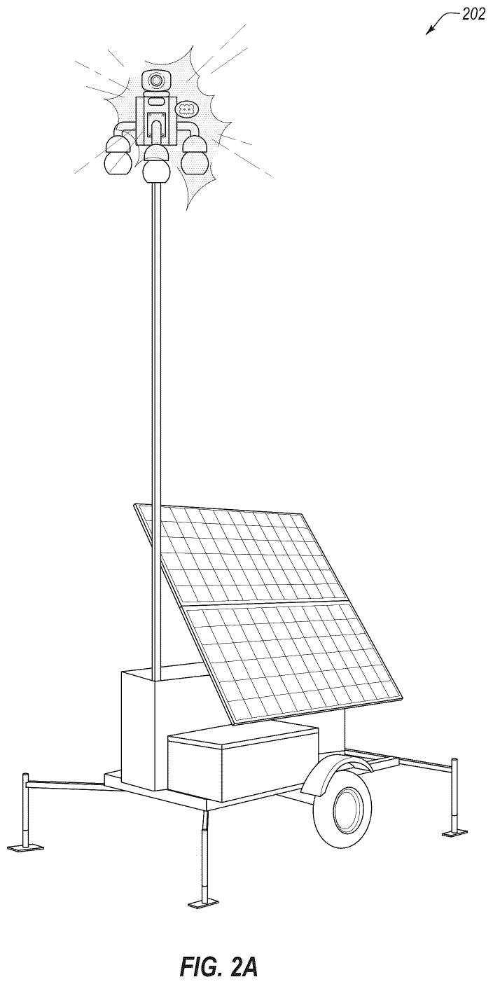

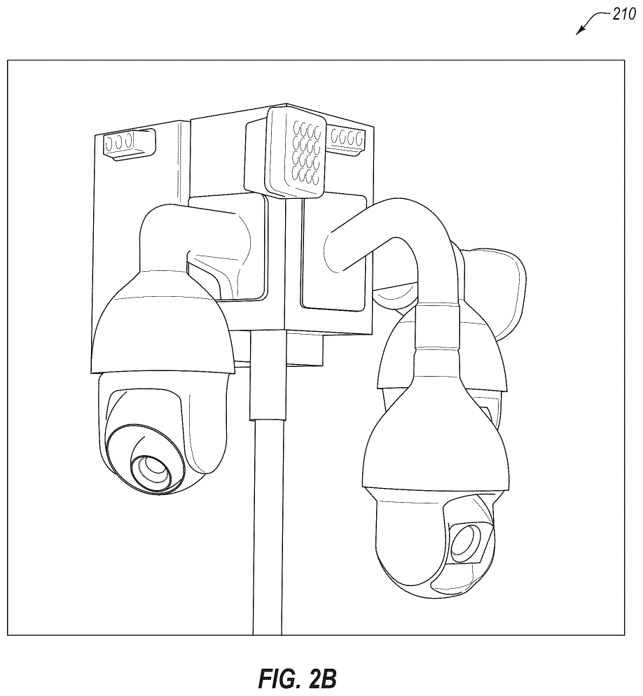

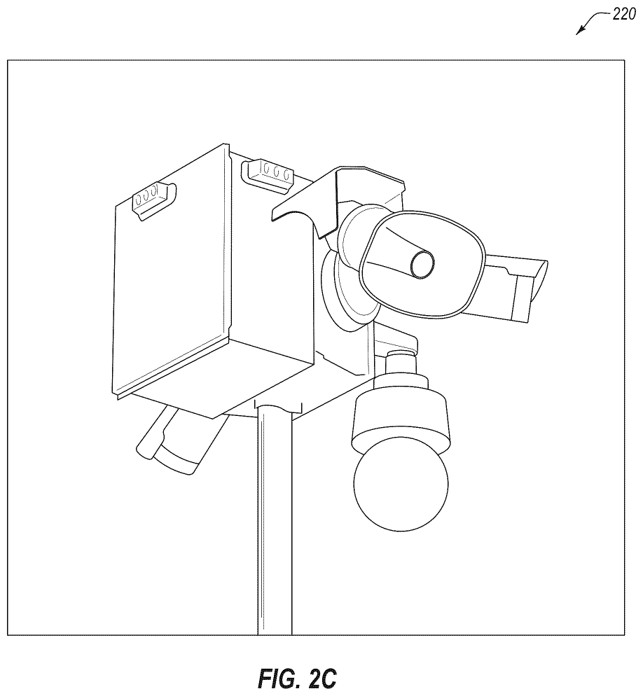

Non-limiting examples of unit 102 are shown in FIGS. 2A-2C. More specifically, FIG. 2A illustrates a mobile unit 202 including a trailer, a storage box, a mast, and a head unit; FIG. 2B illustrates a head unit 210 (i.e., of a mobile unit) including a number of lights, a number of cameras, and a speaker; and FIG. 2C is another depiction of a head unit 220 (i.e., of a mobile unit) including a number of lights, a number of cameras, and a speaker.

It is noted that control of unit 102, and more specifically control of sensors 104 and output devices 106, and any processing and/or control of associated data, may be performed locally (e.g., via computer 110), remotely (e.g., via server 116, electronic device 113, or other device), or some combination thereof. Further, in some embodiments, control of sensors 104 and output devices 106 may be at least partially based on external data (e.g., data received from a source other than unit 102, such as data from another device (e.g., another unit), data from a weather data source, data from a traffic data source, or any other data from any other source).

As will be appreciated by a person having ordinary skill, known and suitable processing techniques (e.g., image and/or video processing) may be used to detect and identify objects and/or acts (e.g., humans, vehicles, weapons, animals, actions (e.g., human running, humans fighting, etc.), and/or other objects and/or acts). Moreover, various analytics and/or processing may be performed on data (e.g., raw data) (e.g., sensed via one or more of sensors 104) to generate data that may be used to control operation of unit 102 and/or another unit.

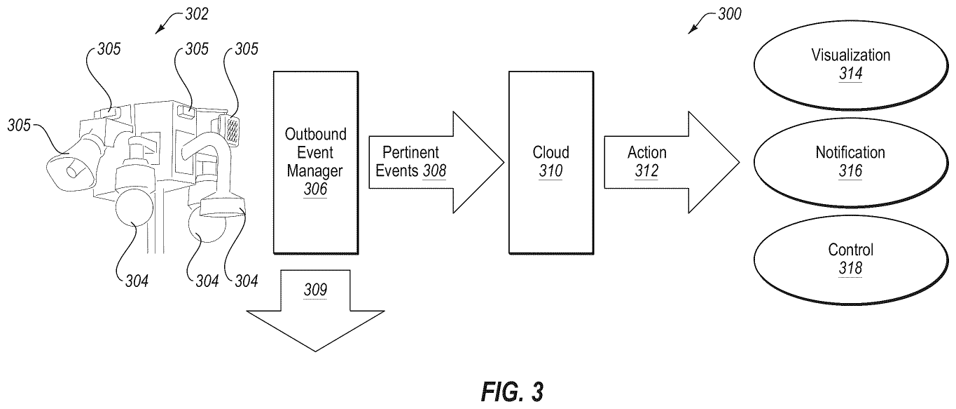

As noted above, various embodiments of the disclosure relate to complex event processing, and associated methods, systems, units, and computer-readable media. FIG. 3 depicts an example event processing system 300. System 300 includes a unit 302 including one or more sensors 304 and one or more output devices 305. For example, sensors 304 may include one or more cameras, weather sensors, microphones, motion sensors, noise sensors, temperature sensors, chemical sensors, any other suitable sensor, and/or any combination thereof. Output devices 305 may include, for example, lights, speakers, displays, any other suitable output device, and/or any combination thereof. In some examples, unit 302 may include a mobile unit (e.g., a mobile surveillance/security unit).

As will be appreciated, some cameras, such as cameras made by Axis Communications AB of Lund, Sweden, Bosch Security Systems, Inc. of New York, USA, and other camera manufacturers, may be configured for hardware-based event generation (i.e., to generate events in response to sensor data). Accordingly, in some embodiments, sensors 304, in response to captured data, may generate one or more events (e.g., via hardware-based event generation (e.g., performed by one or more cameras)) and convey the generated events to an event manager 306. In other words, in some embodiments, a sensor, such as a camera, may be configured to generate an event based on sensed data. In response to receipt of the generated events, event manager 306 may convey pertinent events 308 to a processor 310 (e.g., a cloud-based processor). As will be appreciated, event manager 306 may filter received events to generate pertinent events 308. In some embodiments, event manager 306 may be part of a controller (e.g., of unit 302).

Events (e.g., pertinent events 308, other events, and/or other data) may also be conveyed to another device 309, such as a 3^{rd} party or another unit (e.g., another mobile unit). Further, processor 310 may generate and/or cause one or more actions (e.g., responses) 312 to occur. For example, actions 312 may include a visualization 314 and/or a notification 316, as described more fully below. Actions 312 may also include control 318 of unit 302, another unit (e.g., another mobile unit), and/or another device. For example, control 318 may include opening or closing (or locking) a door or a gate (e.g., a customer gate or door), turning on a customer siren, turning on and/or modifying customer lights, controlling a vehicle (e.g., a drone or other autonomous vehicle). For example, based on events captured via unit 302, the functionality of unit 302 and/or another unit may be controlled (e.g., adjusted). More specifically, for example, in response to sensed events, additional and/or different functionality (and/or additional data) may be requested (e.g., of unit 102, another unit, and/or another device).

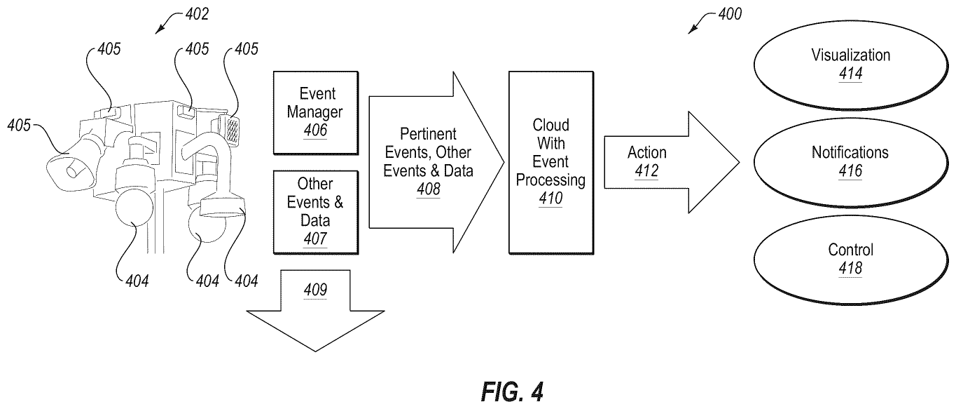

FIG. 4 illustrates another example event processing system 400, according to various embodiments of the disclosure. System 400 includes a unit 402 including one or more sensors 404 and one or more output devices 405. Unit 402, which may include unit 302 of FIG. 3, may convey events to an event manager 406, which may process and/or filter the events and convey pertinent event information and/or other events/data 408 to a processor 410 (e.g., a cloud-based processor). In some embodiments, at least a portion of event manager 406 may exist on a controller (e.g., of computer 110 (see FIG. 1) of unit 402), in the cloud (e.g., on processor 410), and/or another device and/or system.

In some embodiments, an event may be or include raw data, and a pertinent event may be, include, and/or identify what the associated event means. For example, a pertinent event may include relevant events, such as “human detected,” “human running,” “human falling,” “vehicle detected,” “vehicle moving,” “door opened,” “door closed,” “gunshot detected,” and/or any other suitable event. In some embodiments, additional data related to the pertinent event may be determined. For example, if a human is detected, the color of an article of clothing (e.g., a shirt or hat) worn by the human and/or the color of the human's hair may be determined. As another example, if a vehicle is detected, the color of the vehicle, style of the vehicle, and/or the license plate number of the vehicle may be determined.

In other embodiments, an event (e.g., captured via a sensor, such as a camera) may include additional detail (e.g., including information regarding what the associated event means). For example, an event may include, for example, “human detected,” “vehicle detected,” “vehicle moving,” or “door opened.” In these embodiments, events may be filtered by event manager 406 such that only relevant events (e.g., events of interest) are conveyed as pertinent events. Filtering events may reduce an amount of data (e.g., cellular data) transmitted (e.g., to a remote server) and may reduce a number of events (e.g. possibly reducing event/alarm fatigue).

As will be appreciated, a detected event may not be a pertinent event in some scenarios but may be a pertinent event in other scenarios. For example, if a “human detected” event or a “door opened” event occurs during hours in which a business is open, the event may not be forwarded (e.g., by event manager 406) as a pertinent event (i.e., it may be determined that the event is not relevant). However, if a “human detected” event or a “door opened” event occurs during hours in which the business is closed (e.g., at 2 AM), the event may be forwarded (e.g., by event manager 406) as a pertinent event. As another example, a “human detected” event may not trigger a pertinent event initially, however if the detected human loiters for a time duration (e.g., 1 minute, 2 minutes, 5 minutes, or any other time duration), a “human detected” or a “human loitering” event may be forwarded (e.g., by event manager 406) as a pertinent event.

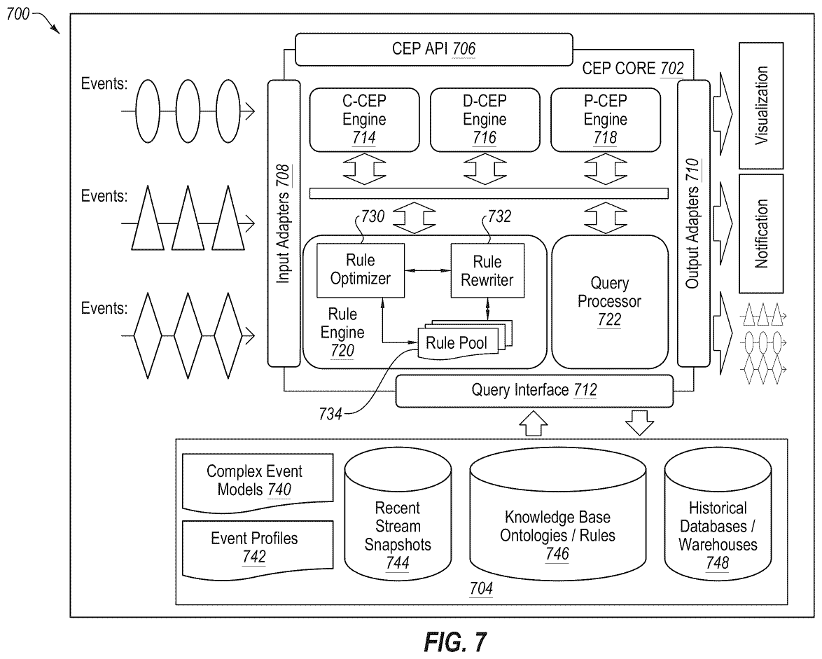

In some embodiments, additional sensor data (e.g., from one or more cameras, sound detectors, motion sensors, or from any other sensors) may be used to determine whether a detected event is a pertinent event. In various embodiments, whether or not an event is a pertinent event may depend at least partially on a model (e.g., an event model 740; see FIG. 7) (e.g., that may define events) and/or one or more system settings.

Further, for each sensed event, event information (e.g., pertinent event information) may include associated information (e.g., event profile information), such as a time and a location of the sensed event. For example, event information and/or other event/data 408 may be generated via hardware (e.g., via hardware-based event generation), software (e.g., via software-based event generation), or a combination thereof. In some embodiments, events and/or other data (e.g., event information and/or other events/data 408) may be conveyed to another device 409, such as a third party (e.g., a third-party device) or another unit (e.g., another mobile unit).

As will be described more fully below, additional events and/or data (e.g., conveyed to processor 410) may include, for example only, event and/or data generated via an artificial intelligence (AI) unit, a front-end device (e.g., a browser and/or an API), an external source, and/or any other source.

Further, processor 410, which may include a complex event processor, may, in response to pertinent event information and/or other event/data 408, generate and/or cause one or more actions 412, such as a visualization 414, a notification 416, and/or control 418, to occur. As non-limiting examples, visualizations 414 and/or notifications 416 may include and/or be related to one or more output devices (e.g., of a unit, such as unit 402 and/or another unit). More specifically, visualizations 414 may include a light (e.g., a strobe light) being turned on or off, modification of a blinking pattern or color of a light (e.g., blinking red lights), modification of an electronic display, and/or another visual act (e.g., associated with system 400). Further, as non-limiting examples, notifications 416 may include an audible notification, such as an audible alarm, a siren, a verbal announcement (e.g., message and/or warning conveyed via a speaker of unit 402 or another unit), or other notification (e.g., associated with system 400). Other acts may be performed responsive to action 412, such as logging an event, and/or recording data (e.g., sensor data captured via unit 402). In some embodiments, action 412 may include transmission of a message (e.g., text and/or email) to, for example, a front-end device (e.g., to a user and/or an administrator). Moreover, action 412 may include placement of a telephone call (e.g., to a user and/or an administrator).

Actions 412 may also include control 418 and/or modification of unit 402 and/or another device or system (e.g., a unit, such as another mobile unit). More specifically, for example, action 412 may include control and/or modification of one or more components (e.g., output devices and/or sensors) of unit 402 and/or another unit (e.g., a unit in the vicinity of unit 402) of system 400. In some embodiments, control 418 may include a request for additional data, wherein the request may cause one or more components of unit 402 and/or another unit to modify its behavior.

As noted above, control is not limited to control of a unit; rather control of any unit and/or any other device (e.g., 3^{rd} party device) may be within the scope of the disclosure. For example, control 418 may include (e.g., in response to an event) opening or closing (or locking) a door or a gate (e.g., a customer gate or door), controlling a drone or other unmanned vehicle (e.g., an autonomous vehicle), turning on a customer siren and/or turning on and/or modifying customer lights (e.g., within a customer store or parking lot), and/or control of any other device that may deter or hinder an activity (e.g., a theft or an assault).

As a more specific example, if unit 402, which is positioned within a customer parking lot, detects an event, system 400 may control unit 402, another unit (e.g., in the parking lot or in another environment), and/or another device or system, such as, for example only, the customer's PA system, the customer's lighting system, the customer's doors and/or gates, and/or any other device or system.

Further, it is noted that an event or control may be at least partially based on data from other sources (i.e., other than a unit). For example, system 400 may receive and possibly act on data from another source (e.g., 3^{rd} party data). As one example, system 400 may receive an alert regarding an approaching weather event (e.g., tornado), and in response thereto, may control unit 402, another unit, and/or another device (e.g., 3^{rd} party device). As another example, system 400 may receive an alert regarding an escaped fugitive or another wanted person, and in response thereto, may control unit 402, another unit, and/or another device. Thus, “sensor data” or the like is not limited to data sensed via a unit (e.g., unit 402 or another unit of system 400); rather sensor data may include received data (e.g., received from another source), data generated based at least partially on received data (e.g., received from another source), and/or known data. As non-limiting examples, this data may include global data, internal customer data, and/or other data. Further, for example, sensor data may include hardware sensed/generated data and/or data generated or sensed via, for example, software sensors (e.g., intelligent sensors).

According to various embodiments, a system (e.g., system 400) may include a server (e.g., a cloud server (e.g., including at least a portion of processor 410)) and a number of units (e.g., a mesh of units (e.g., including unit 402)), wherein each unit may be configured to sense and provide data to the server. In these embodiments wherein each unit of the system may have a common goal (e.g., to keep an environment safe and/or keep people or entities informed), data from one or more units may be used to request additional functionality (e.g., request one or more units of the system to perform a specific function) and/or make a decision (e.g., determine a pattern, determine a plan, reach a conclusion, achieve a goal, without limitation) regarding the system. As will be appreciated, increasing the number of units of a system, and receiving data from multiple units (e.g., with different perspectives and/or capabilities) may provide an enhanced data set, which may increase the accuracy and/or confidence of the functionality, determinations, and/or decision making of the system.

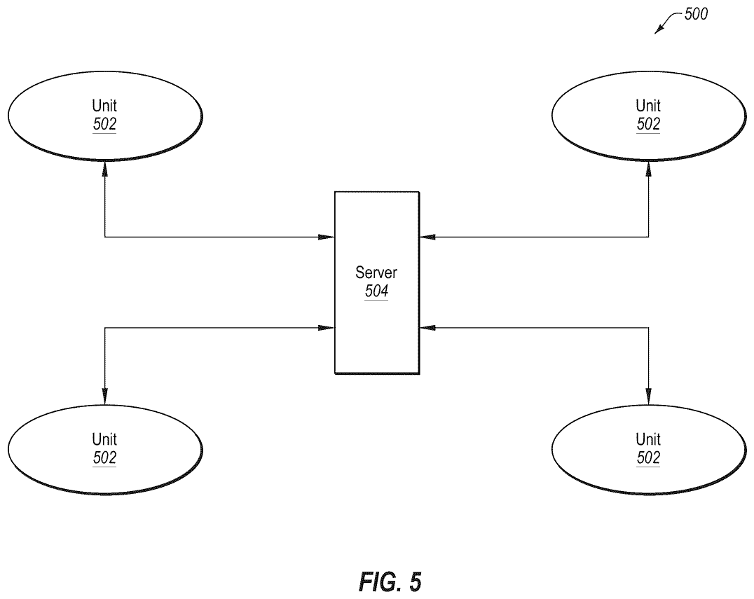

For example, FIG. 5 illustrates a system 500 including a number of units 502 and a server (e.g., cloud server) 504, according to various embodiments of the disclosure. Although system 500 only includes four units 502, system 500 may include any number of units. Further, the units of system 500 may be located throughout an environment, such as in a city or town, along a roadway, in or near one or more parking lots, in or near a construction zone, in or near one or more schools, in or near a concert or sporting venue, or any other environment. In some embodiments, each unit 502 may be configured to sense data, which may be provided to server 504. In some examples, server 504 may be configured to send commands and/or data to one or more units 502. Further, in some examples, one or more units 502 may be configured to send commands and/or data (e.g., sensed data) to other units 502. In these embodiments, system 500 may include and/or function as a mesh of units 502.

For example, data sensed via one unit may be used to control functionality of the one unit and/or one or more other units. As one, more specific example, if a first unit of a system senses an event in an environment (e.g., a suspect in a northwest corner of parking lot), system 500 may request that one or more other units of system 500 adjust an associated camera to focus toward the direction of the northwest corner of parking lot (e.g., to locate and follow the suspect) such that additional data (e.g., images, video, audio) may be captured. Further, system 500 may request that the first unit and/or one or more other units of system 500 turn on a light (e.g., a spotlight, a flashing (e.g., colored) light) and/or convey a sound (e.g., siren, a beep, verbal message, etc.) in the direction of the suspect. In this embodiment, data captured via system 500 may be used to determine a course of action (e.g., request additional functionality and/or data), generate a visualization (e.g., visualization 414; see FIG. 4), a notification (e.g., notification 416; see FIG. 4), and/or reach a conclusion regarding a situation in the environment.

In another example, a sound (e.g., a gunshot, a scream, a vehicle crash, etc.) may be detected by a plurality of units (e.g., units 502) within an environment and based on sensor data from the plurality of units (e.g., via triangulation), a location and/or a direction of the sound may be determined. In another example, a speed of a detected object (e.g., a vehicle) may be determined (e.g., via Doppler technology). As yet another example, if one unit of system 500 detects an object, but system 500 is unable to determine what the object is and/or what event is occurring within a certain level of confidence (i.e., based on data from the one unit), system 500 may request that the unit and/or another unit of the system modify its behavior (e.g., request that the unit direct a strobe light toward the object and another unit of system 500 turn on (e.g., switch to) and direct its thermal camera toward the object (i.e., to capture different data)). In this embodiment, data captured via any number of units of system 500 may be used to determine a course of action (e.g., request different and/or additional data and/or functionality) and/or reach a conclusion regarding the object.

As another example, if one unit within system 500 detects a suspicious vehicle (e.g., traveling by), system 500 may alert other units of system 500 to attempt to locate and track the vehicle (i.e., to capture additional data). For example, a pattern of behavior of the vehicle may be detected, and the pattern of behavior may be used to request additional data, generate an alert and/or another output, reach a conclusion, and/or determine a course of action.

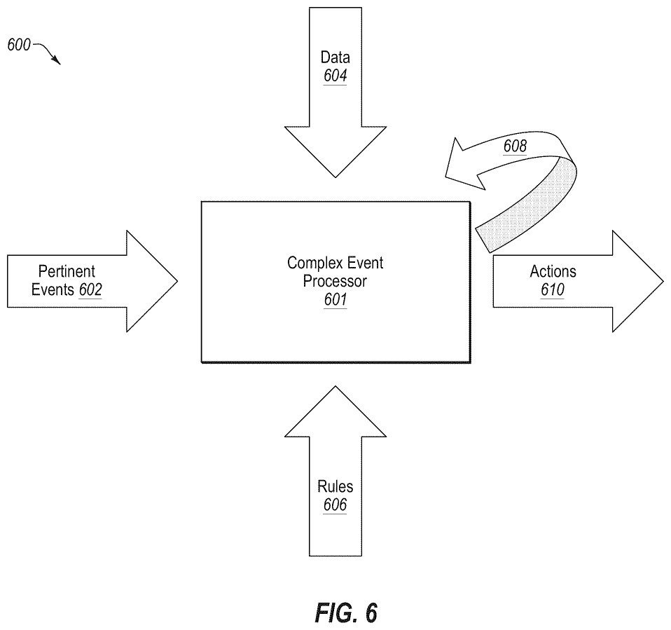

FIG. 6 illustrates an example event processing system 600 including a processor 601, in accordance with various embodiments of the disclosure. For example, according to some embodiments, system 600 may include a complex event processing (CEP) system wherein processor 601 includes a complex event processor. For example, processor 601 may include processor 410 of FIG. 4.

In some embodiments, system 600 may be implemented in the cloud and/or within a device, such as a mobile unit (e.g., unit 402 of FIG. 4), as described more fully below. In some embodiments, system 600 may be a cloud-based system including a cloud-based processor, which may or may not be configured to operate in conjunction with another processor within a device, such as a mobile unit (e.g., unit 402 of FIG. 4).

System 600 may be configured to receive events 602, data 604, rules 606, and events 608. System 600 may further be configured to generate actions 610 (e.g., at least partially based on events 602, data 604, events 608, and/or rules 606). Data 604 may include relevant data, such as user data, client data, owner data (e.g., identifying an owner or lessee of unit 402; see FIG. 4), location data, historical data, and/or any other relevant data associated with system 600. Rules 606 may include reaction rules associated with the invocation of actions in response to detected events and actionable situations. Rules 606 may state the conditions under which actions 610 may or must be taken.

For example, events 602 may include pertinent events and events 608 may include higher-order events. As noted above, pertinent events may include any detectable event, such as an event related to object detection (e.g., a human, a car, an animal, a weapon, without limitation), an event related to object action detection (e.g., object running, object lying down, door opening, car traveling, etc.), an event related to sound detection (e.g., a gunshot, a voice, a scream, a vehicle crash, etc.), an event related to motion detection, an event related to environment detection (e.g., gas and/or smoke), and/or any other detectable event that is considered relevant to a system. It is noted that events 602 may be sensed by one or more units (e.g., units 402 of FIG. 4). For example, a plurality of units with a system and positioned with an environment may sense and provide events 602 to processor 601.

Higher-order events 608, which are fed back into processor 601, may include events generated via processor 601 based on one or more other events. For example, in response to receipt of an event A and an event B, processor 501 may generate (i.e., based on event A, event B, rules 606, and/or data 604), an action C (e.g., A+B=>C). In some examples, action C may include a higher-order event, which may be fed back into processor 601. Upon receipt of higher-order event C and possibly another event (e.g., event D), processor 501 may generate (i.e., based on event C, event D, rules 606 and/or data 604), an action E (e.g., C+D=>E or C=>E).

As one example, event A may include “human exited vehicle” and event B may include “the human is walking toward a store.” In this example, a “human approach or entering store” event may be generated as event C, which, based on a rule, may or may not trigger a response (e.g., an audible or visual notification conveyed via a mobile unit (e.g., unit 402 of FIG. 4)). Further, event C (e.g., “human approach or entering store”) may be fed back into processor 601. Further, in response to event C and event D, which in this example includes “human placing unpurchased goods in pockets,” action E (e.g., track the human and/or alert security (e.g., via text message)) may be generated.

As a more specific example, event C may include “detection of a human entering a store” and event D may include “human placing unpurchased goods in pockets.” In this example, a “possible theft” event may be generated as event F, which, based on a rule, may or may not trigger a response (e.g., an audible or visual notification conveyed via a mobile unit (e.g., unit 402 of FIG. 4)). Further, event F (e.g., “possible theft”) may be fed back into processor 601. Further, in response to event F and event G, which in this example includes “the human moving toward an exit of the store without paying,” action H (e.g., lock store doors and/or alert security (e.g., via text message)) may be generated.

As another example, an event M (i.e., received at processor 601) may include “detection of a vehicle in a store parking lot” and an event N (i.e., received at processor 601) may include “detection of the vehicle stopping and human exiting the vehicle.” Based on one or more rules, event M and/or event N may not trigger a response during a first time window (e.g., 6:00 AM-10:59 PM, while a store is open). However, if event M and event N occur during a second time window (e.g., 11:00 PM-5:59 AM, while a store is closed), an event P (e.g., “suspicious behavior”, which may trigger a response (e.g., an audible or visual notification), may be generated (e.g., via a mobile unit (e.g., unit 402 of FIG. 4)). Further, event Q (e.g., “suspicious behavior”) may be fed back into processor 501. Further, in response to event Q, an event R (e.g., detection of another human) and an event S (e.g., detection of a weapon), an action T (e.g., notify police, turn on spotlight, and/or sound a high intensity alarm) may be generated.

FIG. 7 depicts an example system 700, in accordance with various embodiments of the disclosure. System 700 is one, non-limiting example implementation of system 600 of FIG. 6. System 700 includes a core 702 and a storage 704.

Core 702, which may include a CEP core, may include an API (e.g., CEP API) 706, an input (e.g., an input adapter) 708 (e.g., to receive events), an output (e.g., an output adapter) 710 (e.g., to route actions and higher order events to, for example, generate notifications and/or visualizations, and/or input event streams), and an interface (e.g., a query interface) 712.

Core 702 may further include a number of engines including, for example, a computational CEP engine 714 (e.g., to sense/recognize/identify known event patterns) (also referred to herein as a “real-time pattern-recognition CEP engine”), a detection CEP engine 716 (e.g., to identify and/or classify unknown patterns as new events), a predictive CEP engine 718 (e.g. to predict occurrence of future events (e.g., based on historical data)), and a rules engine 720 (e.g., including declarative rules for complex event patterns). For example only, a “pattern” may be or include multiple discrete events (e.g., from one or more sources (e.g., one or more sensors of a single unit or sensors from multiple units)) grouped together in a unique format/combination.

According to various embodiments, as events are detected, computational CEP engine 714 may check to see if patterns across events match a rule. Computational CEP engine 714 may keep track of the dynamic qualities of patterns (e.g., event sequence, count, timing between events, etc.) to match against known patterns in any of the persistent stores (e.g., recent streams, knowledge base, historical databases). As an example, a rule may be: if a person loiters for at least 3 min then enters a building during closed business hours, a possible break-in event may be triggered. In this scenario, an actor is the person, a first action is “loiter for three or more minutes,” and a second action is “entered building,” and a triggered event is “possible break-in.” Further, in this scenario, detection and notification may be set to occur only while the associated business is closed.

Detection CEP engine 716 may use AI (e.g., machine learning and/or data mining) to detect new event patterns. Detection CEP engine 716 may focus on patterns that are not matched by computational CEP engine 714. If a new pattern is detected, detection CEP engine 716 may modify existing rules or create new rules for detection.

Rules engine 720 may include a rule optimizer 730 (e.g., for selecting proper rule set(s) for received events (e.g., a known pattern)), a rule rewriter 732 (e.g., for converting a rule into a different form and/or adjusting a rule (e.g., based on feedback) to, for example, increase the accuracy of the rule), and a rule pool 734 (e.g., for storing rules). For example, based on received data and/or knowledge derived from received data, priorities (e.g., weights) of rules may be adjusted. Rules engine 720 may modify existing rules based on the event attributes of a matched event pattern and user feedback on whether the resulting event was accurate or a false-positive. For example, an event pattern may include one or more collateral events and/or an event pattern may be associated with (e.g., accompanied with) a particular sound.

Storage 704 may include data such as, for example, event models 740, event profiles 742, stream snapshots 744, a knowledge base 746 (e.g., including ontologies and/or rules), and a historical database 748 (e.g., including captured data). As will be appreciated, an event model may include a trained model that may be used to generate (e.g., via analysis and/or synthesis of one or more codes) an event based on captured data (e.g., raw data (e.g., one or more codes)). As will also be appreciated, an event profile may include an event and associated information, such as a location and/or a time of the event.

Core 702 may also include a query processor 722, which, via utilizing interface 712, may access, based on or more received events, event models 740, event profiles 742, stream snapshots 744, knowledge base 746, and historical database 748. Further, based on received data, query processor 722 may convey data to one or more of computational CEP engine 714, detection CEP engine 716, and predictive CEP engine 718.

In some embodiments, the engines and/or processor of CEP core 702 may receive and/or send data via a data bus (also referred to as an interaction layer).

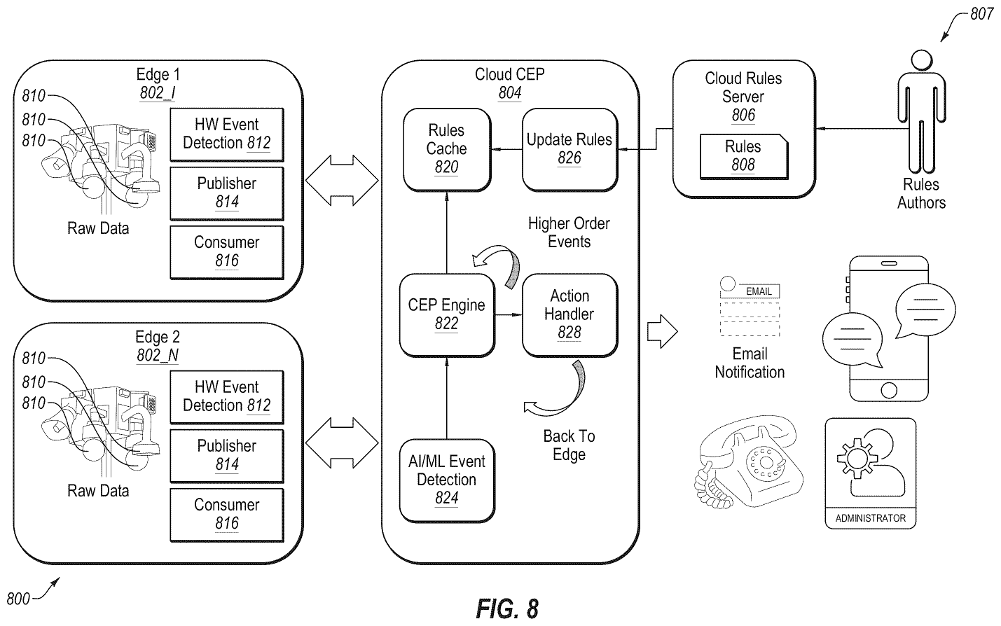

FIG. 8 depicts a system 800, according to various embodiments of the disclosure. System 800 includes a number of units 802_1-802_N, a processor 804 (e.g., a cloud-based processor), and a server 806, which may include a cloud-based rules server including rules 808. For example, rules 808 may be generated via a rules author 807. As an example, processor 804 may include at least a portion of core 702 of FIG. 7.

Each unit 802 may include one or more sensors (e.g., cameras, microphones, motions sensors, sound detectors, etc.) 810, an event detector 812, a publisher 814, and a consumer 816. In some embodiments, event detector 812, publisher 814, and/or consumer 816 may be part of a controller (e.g., of computer 110 (see FIG. 1) of unit 802).

According to some embodiments, sensor(s) 810 may be configured for capturing raw data and generating events based on the raw data (e.g., based on hardware event generation). Further, event detector 812 may be configured for receiving events (e.g., from sensors 810), and generating pertinent events (e.g., based on processing and/or filtering of received events). Further, publisher 814 may push (e.g., write) pertinent events (e.g., into processor 804) and consumer 816 may receive (e.g., read) data (e.g., events or other data) (e.g., from processor 804). For example only, each unit 802 may include a mobile unit, as described more fully below. More specifically, for example, each unit 802 may include a mobile surveillance unit, such as unit 402 of FIG. 4.

Processor 804 includes a rules cache 820, an engine 822 (e.g., a CEP engine), an event detector 824 (e.g., an artificial intelligence/machine learning (AI/ML) event detector), a rules update module 826, and an action handler 828.

A contemplated non-limiting operation of system 800 will now be described. Data may be sensed via at least one unit 802. For example, one or more sensors (e.g., a camera, a weather sensor, a microphone, a motion sensor, a noise sensor, a temperature sensor, a chemical sensors, and/or any other suitable sensor) of one or more units 802 may sense data, which may be converted, via associated event detector 812, to an event (e.g., a “human detected,” a “human running,” a “human falling,” a “vehicle detected,” a “vehicle moving,” a “door opened,” a “gunshot detected,” and/or any other suitable event). At least some of the generated events may be conveyed from unit 802 (e.g., via associated publisher 814) to CEP engine 822 of processor 804. Moreover, in some examples, events sent from event detector 824 (e.g., an AI/ML event detector) may be received at CEP engine 822.

Based on rules received via rules cache 820 and events (e.g., events from unit(s) 802 and/or event detector 824), CEP engine 822 may determine and convey one or more actions to action handler 828, which may cause an action to be performed. For example, action handler 828 may cause one or more responses (also referred to herein as “acts” or “actions”). More specifically, for example, action handler 828 may trigger transmission of a message (e.g., text, email, and/or other message) (e.g., to a user, an administrator, security personnel, and/or a police officer), cause a phone call to be placed (e.g., to a user, an administrator, security personnel, and/or a police officer), cause one or more units 802 to be controlled (e.g., modification of a behavior of unit 802), recordation of data (e.g., log an event or other data associated with unit 802), and/or another action or response. Further, at any time, rules 808 may be received from rules author 807 (e.g., an administrator). Rules 808 may be sent from server 806 to processor 804 to update rules cache 820.

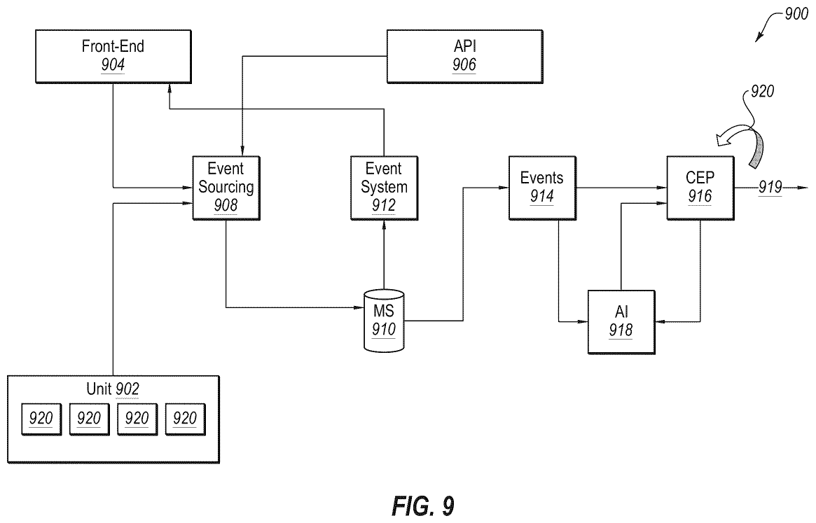

FIG. 9 depicts an example system 900, according to various embodiments of the disclosure. System 900 includes a unit 902, a front-end device 904, an API 906, event sourcing 908, a database (e.g., message store) 910, an event system (e.g., real-time event system) 912, events 914, a CEP unit 916, and an AI system 918. For example, unit 902 may include unit 402 (see FIG. 4), unit 702 (see FIG. 7), and/or another unit. Further, CEP unit 916 may include processor 410 (see FIG. 4), processor 601 (see FIG. 6), core 702 (see FIG. 7), processor 804 (see FIG. 8), and/or another CEP unit.

Unit 902, which may include a mobile unit (e.g., a mobile surveillance and/or security unit), may include a number of sensors 920, such as one or more cameras and/or other sensors. Unit 902 may be configured to convey event data to event sourcing 908. For example, event data may include data related to detection of an event at or near unit 902. More specifically, for example, the event data may be, or may be related to, a detected pertinent event, such as a door opening, detection of an object (e.g., a person, a car, an animal, etc.), detection of an act, a detected motion, a detected sound, a detected chemical, detected weather event, and/or another event.

Further, front-end device 904, which may include a user device, such as a mobile device or a desktop device (e.g., including a web browser), may send one or more events to event sourcing 908. For example, upon a customer being added to system 900, a customer added event may be sent to event sourcing 908. As another example, if a camera of unit 902 was replaced or serviced, a service event may be sent to event sourcing 908. Moreover, a request sent from API (an “API request”) 906, may be received at event sourcing 908 (e.g., as an event).

Event sourcing 908 may be configured to convey each event to database 910, which may include, for example, an audit trail for all events associated with system 900. Database 910 may convey at least some events to event system 912, which may be configured to route events to front-end device 904. Further, events 914 may be routed from database 910 to CEP unit 916. CEP unit 916 may also receive rules (e.g., rules from a rules cache (e.g., rules cache 820 of FIG. 8)) and/or other data associated with system 900.

In response to receipt of one or more events and possibly one or rules, CEP unit 916 may generate an action 919. For example, an action generated via CEP unit 916 may trigger transmission of a message (e.g., text, email, and/or other message), cause placement of a phone call, cause one or more units 902 to be controlled (e.g., behavior modification, such as turning lights of unit 902 on or off, audibly conveying sound (e.g., a horn, a siren, an audible message, etc.)) via unit 902, recordation of data (e.g., log an event or other data), and/or another action. In some cases, an action generated via CEP unit 916 may include a higher-order event 920, which may be fed back into CEP unit 916.

Further, AI system 918 may receive data (e.g., video and/or images) captured via unit 902 and, in response to the data, may convey events (e.g., generated via AI system 918) to CEP unit 916. Events generated via AI system 918 may be considered learning-based events.

Although only one unit 902 is illustrated in FIG. 9, the disclosure is not so limited. Rather, in some embodiments, a system (e.g., system 900) may include a plurality of units 902 (i.e., in one or more locations), wherein CEP unit 916 may be configured to receive events from one or more of the plurality of units 902. Similarly, according to some embodiments, a system may include one or more AI systems 918.

It will be appreciated that various operations and/or methods described herein may include a training/learning element. Thus, various operations and/or methods may be modified (e.g., based on training) over time to increase efficiency and/or accuracy of the operations and/or methods described herein.

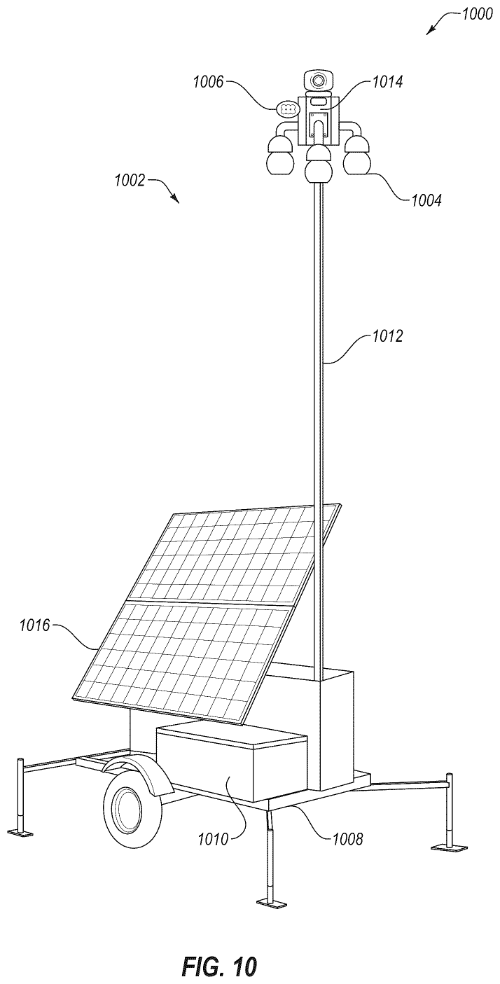

FIG. 10 depicts another example system 1000 including a unit 1002, in accordance with various embodiments of the disclosure. Unit 1002, which may also be referred to herein as a “mobile unit,” a “mobile security unit,” a “mobile surveillance unit,” or a “physical unit,” may be configured to be positioned in an environment (e.g., a parking lot, a roadside location, a construction zone, a concert venue, a sporting venue, a school campus, without limitation). In some embodiments, unit 1002 may include one or more sensors (e.g., cameras, weather sensors, motion sensors, noise sensors, without limitation) 1004 and one or more output devices 1006 (e.g., lights, speakers, electronic displays, without limitation). Unit 1002 may also include at least one storage device (e.g., internal flash media, a network attached storage device, or any other suitable electronic storage device), which may be configured for receiving and storing data (e.g., video, images, audio, without limitation) captured by one or more sensors of unit 1002. According to some embodiments, unit 1002 may include unit 402 of FIG. 4, unit 702 of FIG. 7, and/or unit 802 of FIG. 8.

In some embodiments, unit 1002 may include a mobile unit. In these and other embodiments, unit 1002 may include a portable trailer 1008, a storage box 1010, and a mast 1012 coupled to a head unit (also referred to herein as a “live unit,” an “edge device,” or simply an “edge”) 1014, which may include (or be coupled to) for example, one or more batteries, one or more cameras, one or more lights, one or more speakers, one or more microphones, and/or other input and/or output devices. According to some embodiments, a first end of mast 1012 may be proximate storage box 1010 and a second, opposite end of mast 1012 may be proximate, and possibly adjacent, head unit 1014. More specifically, in some embodiments, head unit 1014 may be coupled to mast 1012 at an end that is opposite an end of mast 1012 proximate storage box 1010.

In some examples, unit 1002 may include one or more primary batteries (e.g., within storage box 1010) and one or more secondary batteries (e.g., within head unit 1014). In these embodiments, a primary battery positioned in storage box 1010 may be coupled to a load and/or a secondary battery positioned within head unit 1014 via, for example, a cord reel.

In some embodiments, unit 1002 may also include one or more solar panels 1016, which may provide power to one or more batteries of unit 1002. More specifically, according to some embodiments, one or more solar panels 1016 may provide power to a primary battery within storage box 1010. Although not illustrated in FIG. 10, unit 1002 may include one or more other power sources, such as one or more generators (e.g., fuel cell generators) (e.g., in addition to or instead of solar panels).

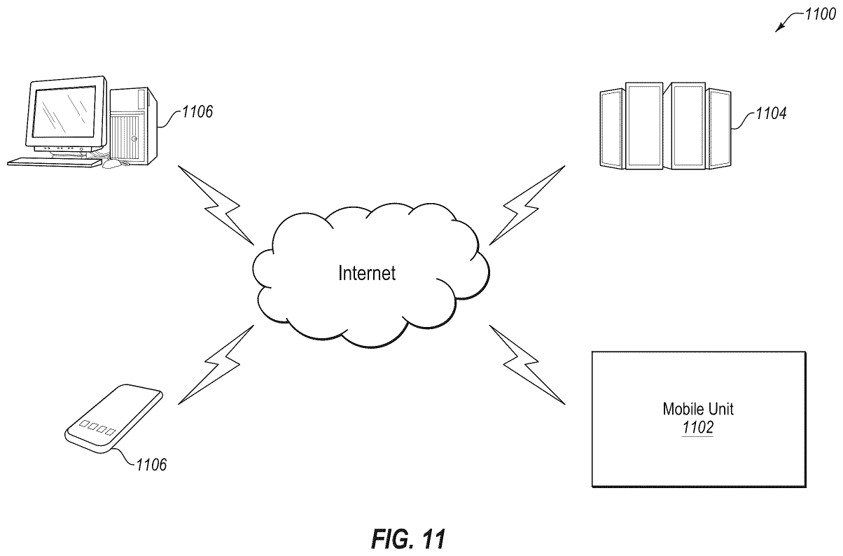

FIG. 11 depicts a system 1100, in accordance with various embodiments of the disclosure. System 1100 includes a mobile unit 1102, a server 1104, and one or more devices 1106. In one non-limiting example, mobile unit 1102 includes mobile unit 1002 (see FIG. 10), server 1104 may include a cloud server or any other server, and device(s) 1106 may include an electronic device, such as a front-end device (e.g., a user device (e.g., mobile phone, tablet, etc.), a desktop computer, or any other suitable electronic device (e.g., including a display)). According to various embodiments, each of server 1104 and device(s) 1106 may be remote from mobile unit 1102. For example, a front end (e.g., front-end device 904 of FIG. 9) may include device(s) 1106. Further, for example, server 1104 may include a cloud-based processor, such as processor 410 of FIG. 4, processor 601 of FIG. 6, system 700 of FIG. 7, processor 804 of FIG. 8, CEP unit 916 of FIG. 9, or another processor and/or system.

According to various embodiments of the disclosure, mobile unit 1102, which may include a modem, may be within a first location (a “camera location” or a “remote location”), and server 1104 may be within a second location, remote from the camera location. In addition, in at least some examples, electronic device 1106 may be remote from the camera location and/or server 1104. As will be appreciated by a person having ordinary skill in the art, system 1100 may be modular, expandable, and/or scalable.

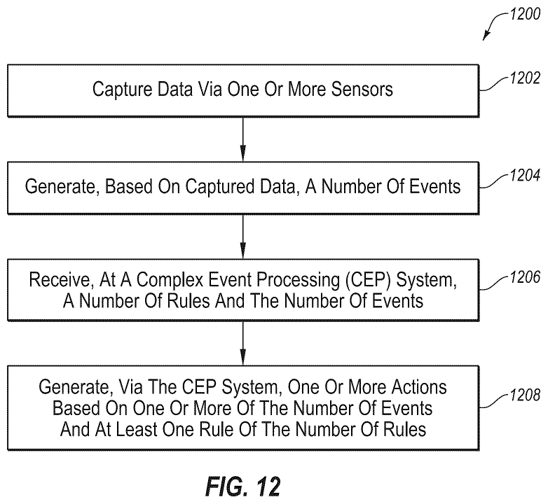

FIG. 12 is a flowchart of an example method 1200 of operating a system.

Method 1200 may be arranged in accordance with at least one embodiment described in the disclosure. Method 1200 may be performed, in some embodiments, by a device or system, such as system 300 (see FIG. 3), system 400 (see FIG. 4), system 500 (see FIG. 5), system 600 (see FIG. 6), system 700 (see FIG. 7), system 800 (see FIG. 8), system 900 (see FIG. 9), system 1000 (see FIG. 10), system 1100 (see FIG. 11), or another device or system. Although illustrated as discrete blocks, various blocks may be divided into additional blocks, combined into fewer blocks, or eliminated, depending on the desired implementation.

Method 1200 may begin at block 1202, wherein data is captured via one or more sensors of a mobile unit, and method 1200 may proceed to block 1204. For example, the mobile unit may include unit 402 of FIG. 4, unit 802 of FIG. 8, unit 902 of FIG. 9, unit 1002 of FIG. 10. Further, as an example, the data may include video and/or audio captured via one or more cameras of the mobile unit.

At block 1204, a number of events may be generated based on the captured data, and method 1200 may proceed to block 1206. For example, “human detected,” “human running,” “human falling,” “vehicle detected,” “vehicle moving,” “door opened,” “gunshot detected,” “gas detected,” and/or any other suitable event may be generated based on the captured data. In some embodiments, the number of events may include hardware (e.g., sensor) generated events and/or pertinent events generated via an event manager (e.g., event manager 406 of FIG. 4).

At block 1206, a number of rules and the number of events may be received at a complex event processing (CEP) system, and method 1200 may proceed to block 1208. For example, the number of events may include one or more events generated via a mobile unit (e.g., mobile unit 1002 of FIG. 10), one or more events generated via an event detector (e.g., event detector 824 of FIG. 8), one or more events generated via a front-end device (e.g., front-end device 904 of FIG. 9), another source, or any combination thereof.

At block 1208, one or more actions may be generated based on the one or more number of events and at least one rule of the number of rules. For example, a message (e.g., an email and/or a text) may be sent (e.g., to a user and/or an administrator), a phone call may be placed (e.g., to a user, an administrator, law enforcement, etc.), data (e.g., an event or other data) may be logged, behavior of one or more of components (e.g., output devices) of a mobile unit (e.g., mobile unit 1002 of FIG. 10) may be controlled and/or modified, another action may be performed, or any combination thereof.

Modifications, additions, or omissions may be made to method 1200 without departing from the scope of the present disclosure. For example, the operations of method 1200 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

As noted above, various embodiments disclosed herein relate to reactive and/or interactive systems. Yet more specifically, various embodiments relate to surveillance and/or security systems configured to interact with and/or to an environment. Stated another way, a system may be configured to sense its environment and react and/or interact accordingly via one or more responses. According to some embodiments, a system may be programmable (e.g., via a user) such that various sensed events may trigger various responses. Further, various embodiments relate to controllable and/or customizable systems. In some of these embodiments, a system may interact with and/or react to an environment with or without a CEP system (i.e., with or without utilizing CEP functionality).

With reference again to at least FIG. 1, various contemplated and non-limiting example operations of system 100 will now be described. In these example operations, unit 102, which may be positioned in an environment (e.g., a parking lot, a roadside location, a construction zone, a concert venue, a sporting venue, a school campus, an agriculture environment, a power substation, a location including a pipeline, a location including a railroad track, without limitation), may be configured to sense activity within and/or near the environment. It is noted that these operations are provided as non-limiting examples and persons having ordinary skill in the art will appreciate that this disclosure includes any embodiment wherein a system (e.g., a security system) may react and/or interact with its environment (e.g., based on an event, configuration, and/or a schedule), and any embodiment wherein operation of a system is controllable and/or customizable (e.g., via one or more programmable schedules, sensor input (e.g., escalation of repeated sensor input, any combination of sensor inputs, etc.), or other event or data).

In one example, initially (e.g., before a sensed event), at least one light (e.g., an LED strobe) of unit 102 may exhibit one behavior (e.g., a blue light flashing with a first intensity (e.g., speed and/or brightness) and/or a first blinking pattern). Subsequently (e.g., in response to a sensed event, such as detection of an object (e.g., a vehicle, a suspect, an intruder, a trespasser, a loiterer, a suspect with a weapon, etc.)), at least one light of unit 102 may exhibit another behavior (e.g., a white light flashing (e.g., in addition to or in place of the blue light) with a second intensity (e.g., a different speed and/or brightness relative to the first intensity) and/or a second blinking pattern). Further, as an example, in response to the sensed event, a speaker of unit 102 may exhibit a behavior (e.g., an alarm (e.g., having a first intensity) may be sounded, a verbal message (i.e., either recorded or live) may be conveyed, and/or another audible response may be conveyed).

Moreover, for example, in response to the object failing to vacate the environment and/or the object getting closer to unit 102 (e.g., within 25 feet, 20 feet, 15 feet, etc.), unit 102 may exhibit yet another behavior wherein, for example only, one or more lights of unit 102 may flash (e.g., white, blue, and red) with a third intensity (e.g., a different speed and/or brightness relative to the second intensity) and/or a third blinking pattern. Further, in this example, a speaker of unit 102 may convey an alarm (e.g., having a second, increased intensity) and/or convey another (e.g., more serious) audible response. Further, in some embodiments, a live operator may verbally communicate (e.g., via a speaker of unit 102) with the object (e.g., via a “talk down” function). In some embodiments, before, during, and/or after conveying a verbal response, unit 102 may further modify behavior of one or more lights of unit 102.

Continuing with this example, in response to sensing an act performed by the object (e.g., a harmful, illegal, or immoral act), operation of one or more output devices 106 of unit 102 may be further modified (e.g., additional lights with various colors, intensities, patterns, etc., may be conveyed and/or an additional audible response (e.g., sounds, alarms, verbal messages, etc.) may be conveyed). As one example, unit 102 may enter a “berserk mode” wherein, for example, a number of lights flash a number of colors and a number of sounds and/or verbal messages (e.g., live and/or recorded) are conveyed via one or more speakers of unit 102. It is noted that depending on a sensed event, and possibly the evolution of the sensed event, the behavior of unit 102 may escalate or deescalate. More specifically, if the object refuses to leave the property (e.g., after being warned), unit 102 may escalate its behavior with additional visual and/or audible responses. On the other hand, if the object vacates the property, unit 102 may deescalate its behavior by reducing the number of visual and/or audible responses.

As another example, initially (e.g., before a sensed event), a light (e.g., a floodlight) of unit 102 may be in a default position and may be in an off state. Subsequently, in response to a sensed event (e.g., detection of a sound), the light of unit 102 may exhibit another behavior (e.g., light may be directed on and/or toward a source of the sound), which may or may not require the light to move. Moreover, in this example, a speaker of unit 102 may convey a sound and/or a verbal message toward the source of the sound. As a more specific example, in response to unit 102 detecting a gunshot, unit 102 may shine light toward the direction of the sound caused by the gunshot.

In yet another example, in response to certain sensed data, such as weather data, unit 102 may enter a weather alert mode wherein unit 102 may convey a visual response (e.g., one or more colors via one or more lights) and/or an audible response (e.g., verbal message) regarding a current or future weather event (e.g., severe wind, extreme heat or cold, hurricane, tornado, etc.). As another example, in response to certain sensed data, such as traffic data, unit 102, which may be positioned on or near a roadway (e.g., a parking lot), may convey a visual response (e.g., one or more colors via one or more lights) and/or an audible response (e.g., verbal message via a speaker) regarding a current or future traffic event or situation.

As another example, during a certain event (e.g., a local or national holiday, a sporting event, an awareness (e.g., breast cancer awareness) month, etc.), unit 102 may be configured to display, via one or more lights, a visual response (e.g., one or more colors) associated with the event. For example, unit 102 may be configured to display team colors of a local sports team (e.g., on game day). As another example, unit 102 may be configured to display the color pink for breast cancer awareness (e.g., during the month of October). Additionally or alternatively, unit 102 may convey, via one or more speakers, an audible response (e.g., a message) associated with the event.

In some embodiments, unit 102 may be configured to operate according to a first standard (e.g., a standard mode) during certain hours of a day (e.g., during daylight hours and/or while an associated business is open) and a second, different standard (e.g., an alert mode) during other hours of the day (e.g., during nighttime hours and/or while the business is closed). In this example, the criteria for triggering an event while operating according to the first standard may be different from the criteria for triggering an event while operating according to the second standard. More specifically, for example, detection of movement within an environment during some hours (e.g., while the business is closed) may trigger an event, while detection of movement within the environment during other hours (e.g., while the business is open) may not trigger an event. For example, the sensitivity of unit 102 may be adjusted based on one or more factors, such as, for example, a location of unit 102, a time of day, a day of the week, and/or another variable. As another example, in response to detection of an event during daylight hours, a reaction of unit 102 may be more focused on an audible response (e.g., via one or more speakers) (i.e., compared to a visual response), and in response to detection of an event during nighttime hours, a reaction of unit 102 may include a visual (e.g., light) response and/or an audio (e.g., speaker) response.

In some embodiments, unit 102 may be configured (e.g., based on a programmable schedule) such that during a first time period (e.g., 7 AM-10 PM), one or more lights of unit 102 may display light at a first intensity level, and during a second time period (e.g., 10 PM-7 AM), one or more lights of unit 102 may display light at a second intensity level (e.g., a less bright level). As another example, during the first time period, one or more lights of unit 102 may display a first color, and during the second time period, one or more lights of security unit 102 may display a second color. In a more specific example, unit 102, which may be positioned in or near an apartment complex, may be configured to adjust its behavior at certain times (e.g., dim one or more lights, turn off one or more lights, turn off audible responses) (e.g., to not disturb residents at night while continuing to monitor its environment).

In yet other embodiments, unit 102 may be configured to monitor its environment and adjust accordingly. For example, if system 100 detects an uptick in traffic and/or activity proximate unit 102 (e.g., vehicle traffic in a retail parking lot, foot traffic at a concert venue or school campus, increased noise, etc.), one or more output devices of unit 102 may react (e.g., via triggering additional lights and/or modifying lighting behavior, triggering an audible response (e.g., additional sounds and/or a verbal message), and/or triggering another response). Further, in response to an uptick in traffic and/or activity, system 100 may adjust (i.e., increase or decrease) a sensitivity thereof (i.e., a sensitivity threshold for triggering events). Further, if system 100 detects a downtick in traffic or activity proximate unit 102, one or more output devices of unit 102 may react (e.g., via reducing a number of displayed lights and/or an intensity of the displayed lights, pausing an audible response, and/or triggering another response). Further, in response to a downtick in traffic and/or activity, system 100 may adjust (i.e., increase or decrease) a sensitivity thereof (i.e., a sensitivity threshold for triggering events).

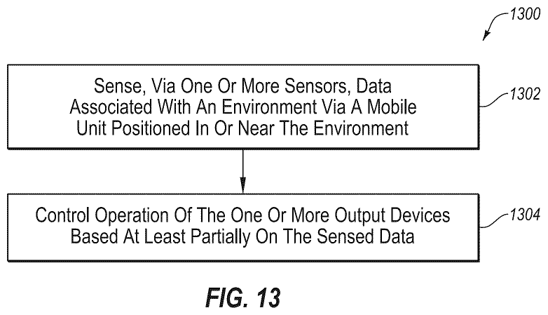

FIG. 13 is a flowchart of an example method 1300 of operating a system (e.g., including a mobile unit). Method 1300 may be arranged in accordance with at least one embodiment described in the disclosure. Method 1300 may be performed, in some embodiments, by a device or system, such as system 100 (see FIG. 1), unit 102 (see FIG. 1), or another device or system. Although illustrated as discrete blocks, various blocks may be divided into additional blocks, combined into fewer blocks, or eliminated, depending on the desired implementation.

Method 1300 may begin at block 1302, wherein data associated with an environment is sensed via one or more sensors of a mobile unit positioned within or near the environment, and method 1300 may proceed to block 1304. For example, one or more cameras of unit 102 (see FIG. 1) may detect, and possibly monitor, an event. More specifically, one or more cameras of unit 102 may detect an object (e.g., human or a vehicle) and determine and/or monitor a behavior of the detected object. As other examples, a noise sensor of unit 102 may detect sound proximate thereto and/or a motion sensor of unit 102 may detect motion proximate thereto.

At block 1304, operation of one or more output devices of the mobile unit is controlled based at least partially on the sensed data. For example, in response to sensed data, the mobile unit may modify a visual response and/or an audible response. For example, in response to the sensed event (e.g., a human being detected), a light, which was blinking a first color (e.g., blue), may begin to blink a second color (e.g., in addition to or in place of the first color). Further, for example, an illumination intensity and/or a speed of a blinking pattern of the light may increase (i.e., in response to the first event). As another example, in response to another sensed event (e.g., the human failing to vacate the surrounding environment), the light may begin to blink a third color (e.g., in addition to or in place of the first color and/or second color (e.g., red, white, and blue)). Further, for example, an illumination intensity and/or a speed of a blinking pattern of the light may increase yet again (i.e., in response to the human failing to vacate). Moreover, in some examples, one or more audible responses (e.g., music, sounds, and/or messages) may be conveyed (i.e., via one or more speakers) (e.g., in response to detecting the human and/or in response to the human failing to vacate the area).

Modifications, additions, or omissions may be made to method 1300 without departing from the scope of the present disclosure. For example, the operations of method 1300 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

In some embodiments, a unit (e.g., unit 1002 of FIG. 10) may be used in a disaster and/or emergency scenario (e.g., for relief (e.g., during or after an event, such as a hurricane, a tornado, a flood, or other situation)). More specifically, in one example, a unit may be configured to produce and provide power. Yet more specifically, a unit, which may include one or more batteries (e.g. primary and backup batteries), may include one or more power outlets enabling an external device to couple to the unit (i.e., to provide power (e.g., from the one or more batteries and/or power generated via a solar panel and/or a generator of the unit) to the external device). Further, for example, a unit may be configured to use stored power to operate one or more output devices. More specifically, a unit may convey messages (e.g., audible messages (e.g., instructions and/or warnings) via a speaker and/or visual messages (e.g., instructions and/or warnings) via a display). Further, in another example, a unit may be configured to provide lighting (i.e., via one or more lights).

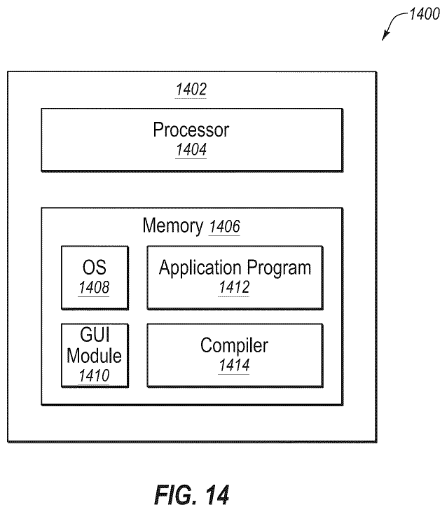

FIG. 14 illustrates a system 1400 that may be used to implement embodiments of the disclosure. System 1400 may include a computer 1402 that comprises a processor 1404 and memory 1406. For example only, and not by way of limitation, computer 1402 may include a workstation, a laptop, or a hand-held device such as a cell phone or a personal digital assistant (PDA), a server (e.g., server 116), computer 110 (see FIG. 1), or any other processor-based device known in the art. In one embodiment, computer 1402 may be operably coupled to a display (not shown in FIG. 14), which presents images to the user via a GUI.

Generally, computer 1402 may operate under control of an operating system 1408 stored in memory 1406, and interface with a user to accept inputs and commands and to present outputs through a GUI module 1410. Although GUI module 1410 is depicted as a separate module, the instructions performing the GUI functions may be resident or distributed in the operating system 1408, a program 1412, or implemented with special purpose memory and processors. Computer 1402 may also implement a compiler 1414 that allows a program (e.g., code) 1412 written in a programming language to be translated into processor 1404 readable code. After completion, program 1412 may access and manipulate data stored in memory 1408 of computer 1402 using the relationships and logic that are generated using compiler 1414.

Further, operating system 1408 and program 1412 may include instructions that, when read and executed by computer 1402, may cause computer 1402 to perform the steps necessary to implement and/or use various embodiments of the disclosure. Program 1412 and/or operating instructions may also be tangibly embodied in memory 1406 and/or data communications devices, thereby making a computer program product or article of manufacture according to an embodiment of the present disclosure. As such, the term “program” as used herein is intended to encompass a computer program accessible from any computer readable device or media. Program 1412 may exist on an electronic device (e.g., electronic device 113; see FIG. 1), a server (e.g., server 116; see FIG. 1), a unit (e.g., unit 102; see FIG. 1), and/or another device. Furthermore, portions of program 1412 may be distributed such that some of program 1412 may be included on a computer readable media within an electronic device (e.g., electronic device 113), some of program 1412 may be included on a computer readable media on a server (e.g., server 116), some of program 1412 may be included on a computer readable media on a unit (e.g., unit 102), and/or some of program 1412 may be included on a computer readable media on another device. In some embodiments, program 1412 may be configured to run on electronic device 113, server 116, unit 102, another computing device, or any combination thereof. As a specific example, program 1412 may exist on server 116 and/or unit 102 and may be accessible to a user via electronic device 113.

Additional non-limiting embodiments of the disclosure include:

Embodiment 1: a system, comprising: a mobile unit positioned within an environment and including: one or more sensors to sense data within or around the environment; one or more lights; and one or more speakers; and a control unit configured to control a behavior of at least one of a light of the one or more lights or a speaker of the one or more speakers responsive to data sensed via the one or more sensors.

Embodiment 2: the system of Embodiment 1, wherein the control unit is configured to control at least one of the one or more lights or the one or more speakers based on a programmable schedule.

Embodiment 3: the system of any of Embodiments 1 and 2, wherein the control unit is configured to control at least one of the one or more lights or the one or more speakers based on at least one of a calendar event, an awareness event, or a sporting event, an external event.

Embodiment 4: a method of operating a mobile security unit comprising one or more sensors and one or more output devices, the method comprising: sensing, via the one or more sensors, data associated with an environment via a mobile unit positioned in or near the environment; and controlling operation of the one or more output devices based at least partially on the sensed data.

Embodiment 5: the method of Embodiment 4, wherein controlling the operation of the one or more output devices comprises controlling operation of at least one of a light or a speaker.

Embodiment 6: the method of any of Embodiments 4 and 5, wherein controlling the operation of the one or more output devices comprises controlling operation of at least one of a color of a light of the mobile unit, a flashing pattern of the light, or an illumination intensity of the light.

Embodiment 7: the method of any of Embodiments 4 to 6, wherein sensing data comprises sensing data via a camera, a noise sensor, a weather sensor, a motion sensor, or any combination thereof.

Embodiment 8: a system, comprising: one or more computer-readable media having instructions stored thereon; and one or more processors communicatively coupled to the one or more computer-readable media and configured to, in response to executing the instructions, perform or control performance of operations, the operations comprising controlling one or more output devices of a mobile security unit based at least partially on data sensed proximate the mobile security unit.

Embodiment 9: the system of Embodiment 8, wherein controlling the one or more output devices comprises controlling the one or more output devices at least partially based on a predetermined schedule.

Embodiment 10: a non-transitory computer-readable media having computer instructions stored thereon that, in response to being executed by a processing device of a system, cause the system to perform or control performance of operations comprising: detecting an event within or near an environment including a mobile security unit; and modifying operation of at least one output device of the mobile security unit responsive to the detected event.

Embodiment 11: the non-transitory computer-readable media of Embodiment 10, wherein: detecting an event comprises detection an event with a camera of the mobile security event; and modifying the operation of the at least one output device comprises displaying a color via at least one light of the mobile security unit.

Embodiment 12: a security system, comprising: a mobile unit including one or more output devices; and at least one controller configured to control at least one output device of the one or more output devices responsive to at least one predetermined schedule.

Embodiment 13: the security system of Embodiment 12, wherein the at least one controller is configured to control the at least one output device according to a first predetermined schedule during a first time period and according to a second predetermined schedule during a second time period.

Embodiment 14: the security system of any of Embodiments 12 and 13, wherein the at least one controller is configured to control the at least one output device responsive to a sensed event.

Embodiment 15: the security system of any of Embodiments 12-14, further comprising at least a power outlet for providing power to a device.

In accordance with common practice, the various features illustrated in the drawings may not be drawn to scale. The illustrations presented in the disclosure are not meant to be actual views of any particular apparatus (e.g., circuit, device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., circuit, device, or system) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used herein, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “approximately” or the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 11.0.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed:

1. A system, comprising:
a mobile unit including:
one or more sensors configured for capturing data; and
a controller for generating a number of events based on captured data; and
a complex event processing (CEP) system communicatively coupled to the mobile unit, the CEP system configured to:
receive one or more events of the number of events; and
generate one or more actions based on at least one event of the one or more events.

2. The system of claim 1, the CEP system further configured to receive a number of rules, wherein the CEP is further configured to generate the one or more actions based on one or more rules of the number of rules.

3. The system of claim 1, further comprising a front-end device coupled to the CEP system, the CEP system further configured to receive a second number of events from the front-end device.

4. The system of claim 3, further comprising a message store configured to receive the second number of events from the front-end device.

5. The system of claim 1, further comprising an artificial intelligence (AI) system configured to:
receive data from the mobile unit; and
generate a second number of events based on the received data, wherein the CEP is configured to receive the second number of events.

6. The system of claim 1, further comprising a message store configured to receive the number of events from the mobile unit.

7. The system of claim 1, wherein at least one of the one or more actions generated via the CEP system is a higher-order event fed back into the CEP system.

8. The system of claim 1, the CEP system further configured to receive data, wherein the CEP is further configured to generate the one or more actions based on at least some of the received data.

9. The system of claim 1, wherein the CEP system comprises a cloud-based processor configured to receive the one or more events and generate the one or more actions.

10. A method of operating a surveillance system, the method comprising:
capturing data via one or more sensors of a mobile surveillance unit;
generating, based on captured data, a number of events;
receiving, at a complex event processing (CEP) system, a number of rules and the number of events; and
generating, via the CEP, one or more actions based on the one or more number of events and at least one rule of the number of rules.

11. The method of claim 10, further comprising receiving, at the CEP, a second number of events from a front-end device.

12. The method of claim 10, further comprising receiving, at a message store, the number of events.

13. The method of claim 10, further comprising receiving, at the CEP, a second number of events from an artificial intelligence (AI) system.

14. The method of claim 10, wherein generating, via the CEP, the one or more actions comprises generating at least one higher-order event.

15. The method of claim 14, wherein generating, via the CEP, the one or more actions comprises generating the one or more actions based on the at least one higher-order event.

16. A system, comprising:
a mobile unit including:
a trailer;
a mast coupled to the trailer; and
a head unit coupled to the mast and comprising:
one or more sensors configured for capturing data; and
a controller for generating events based on captured data; and
a complex event processing (CEP) system communicatively coupled to the head unit, the CEP system configured to:
receive the events; and
generate one or more actions based on one or more of the received events.

17. The system of claim 16, wherein the CEP system includes a cloud-based CEP system.

18. The system of claim 15, wherein the one or more actions include and/or cause at least one of:
control of an output device of the mobile unit;
generation of a message;
placement of a phone call; or
data to be logged.

19. The system of claim 15, wherein the CEP system is further configured to receive a number of rules, wherein the one or more actions are based on at least one rule of the number of rules.

20. The system of claim 15, further comprising a front-end device configured to receive data responsive to the one or more actions.

21. The system of claim 15, further comprising an application programming interface (API), the CEP system further configured to receive an event from the API.

22. A non-transitory computer-readable media having computer instructions stored thereon that, in response to being executed by a processing device of a system, cause the system to perform or control performance of operations comprising:
generating, based on captured data, a number of events;
receiving, at a complex event processing (CEP) system, a number of rules and the number of events; and
generating, via the CEP system, one or more actions based on one or more of number of events and at least one rule of the number of rules.

23. The non-transitory computer-readable media of claim 22, the operations further comprising at least one of:
receiving, at the CEP system, a second number of events from a front-end device;
receiving, at a message store, the number of events; or
receiving, at the CEP, a second number of events from an artificial intelligence (AI) system.

24. A surveillance system, comprising:
a mobile unit including one or more output devices and one or more sensors; and
at least one controller configured to control at least one output device of the one or more output devices responsive to data sensed via one or more sensors.

25. The surveillance system of claim 24, wherein the one or more output devices include one or more lights, one or more speakers, or any combination thereof.

26. The surveillance system of claim 25, wherein the controller is configured to control, responsive to the data, at least one item selected from the group consisting of:
an intensity of illumination of at least one light of the one or more lights;
a blinking pattern of at least one light of the one or more lights;
a color displayed by at least one light of the one or more lights; and
an audible message conveyed via a speaker of the one or more speakers.

27. The surveillance system of claim 24, wherein the one or more output devices comprises a light, a speaker, or both.

28. The surveillance system of claim 24, wherein the mobile unit comprises the one or more sensors, the one or more sensors comprising a noise sensor, a camera, a motion sensor, a temperature sensor, a weather sensor, or any combination thereof.

29. The surveillance system of claim 24, wherein the mobile unit comprises:
a trailer;
a mast coupled to the trailer; and
a head unit including the one or more output devices and the one or more sensors.

30. The surveillance system of claim 24, wherein the mobile unit includes at least one power outlet from providing power to an external device.
